(19) United States
(12) Patent Application Publication
(10) Pub. No.: US 2017/0242287 A1
(43) Pub. Date: Aug. 24, 2017

(54) LIQUID CRYSTAL DISPLAY APPARATUS

(71) Applicant: SAMSUNG DISPLAY CO., LTD., YONGIN-SI (KR)

(72) Inventor: YONGEUN PARK, ASAN-SI (KR)

(21) Appl. No.: 15/435,434

(22) Filed: Feb. 17, 2017

(30) Foreign Application Priority Data
Feb. 19, 2016 (KR) 10-2016-0019679

(51) Int. Cl. G02F 1/1333; G02F 1/1339

(52) U.S. Cl. CPC G02F 1/133308; G02F 1/1339; G02F 2202/28; G02F 2201/503

(57) ABSTRACT

A liquid crystal display apparatus including a display panel having a display area which displays an image and a non-display area, and a window which overlaps the display panel. The display panel includes a first display substrate, a second display substrate, a liquid crystal layer, a sealing member, and a buffer member. The second display substrate is disposed between the first display substrate and the window. The liquid crystal layer is disposed between the first and second display substrates. The sealing member is disposed between the first and second display substrates. The buffer member contacts at least one of the first and second display substrates in the non-display area and is disposed farther away from the liquid crystal layer than the sealing member, wherein the buffer member contacts the sealing member and the window.

### CROSS-REFERENCE TO RELATED APPLICATION

This U.S. non-provisional patent application claims priority under 35 U.S.C. §119 to Korean Patent Application No. 10-2016-0019679, filed on Feb. 19, 2016, the disclosure of which is incorporated by reference herein in its entirety.

### TECHNICAL FIELD

The present inventive concept relates to a display apparatus, and more particularly, to a display apparatus having increased display quality.

### DISCUSSION OF RELATED ART

A display apparatus is used in a variety of devices such as a mobile phone, a notebook computer, a monitor, and a tablet personal computer (PC) to display an image. The display apparatus may include a liquid crystal display apparatus and an organic light emitting display apparatus, as just a few examples. The liquid crystal display apparatus may include two substrates facing each other, a liquid crystal layer, and a sealing member.

The liquid crystal layer is disposed between the two substrates and can control an amount of light transmitted through the two substrates, based on an electric field applied thereto. The sealing member is disposed between the two substrates to couple the two substrates to each other and seals the liquid crystal layer between the two substrates.

The liquid crystal display apparatus may further include a window. The window has a light transmitting property and covers a display area of the display panel. The window is disposed on the outer surface of the liquid crystal display apparatus to protect the display panel from external shock.

### SUMMARY

An exemplary embodiment of the inventive concept provides a liquid crystal display apparatus including: a display panel having a display area which displays an image and a non-display area; and a window which overlaps the display panel.

The display panel includes a first display substrate, a second display substrate, a liquid crystal layer, a sealing member, and a buffer member. The second display substrate is disposed between the first display substrate and the window. The liquid crystal layer is disposed between the first and second display substrates. The sealing member is disposed between the first and second display substrates. The buffer member contacts at least one of the first and second display substrates in the non-display area and is disposed farther away from the liquid crystal layer than the sealing member, wherein the buffer memory contacts the sealing member and the window.

The first display substrate comprises a first edge disposed away from the second display substrate, and the buffer member couples the first edge to the window.

The liquid crystal display apparatus further comprises an adhesive member disposed between the display panel and the window, wherein the buffer member contacts a first side surface of the sealing member, a side surface of the second display substrate, and a first side surface of the adhesive member.

The adhesive member does not overlap the first edge of the first display substrate.

The first display substrate further comprises a second edge coincident with an edge of the second display substrate, wherein, at a side of the display panel where the second edge is located, the buffer member contacts a second side surface of the sealing member, a side surface of the second edge, a side surface of the edge of the second display substrate, and a second side surface of the adhesive member.

The buffer member is a double-sided tape.

The buffer member comprises a first buffer having a linear shape extending along a first edge of the display panel.

The buffer member further comprises a second buffer having a dot-like shape and arranged along a second edge of the display panel.

The buffer member has a height that is substantially the same as a distance between the first display substrate and the window.

The window has a light transmitting property.

In an exemplary embodiment of the inventive concept, a liquid crystal display apparatus includes a display panel having a display area which displays an image and a non-display area, a window which covers the display panel, and an adhesive member disposed between the display panel and the window.

The display panel includes a first display substrate, a second display substrate, a liquid crystal layer, a sealing member, and a buffer member. The second display substrate is disposed between the first display substrate and the window. The liquid crystal layer is disposed between the first and second display substrates. The sealing member is disposed between the first and second display substrates. The buffer member contacts at least one of the first and second display substrates in the non-display area and is disposed farther away from the liquid crystal layer than the sealing member, wherein the buffer member contacts the sealing member and the adhesive member.

The first display substrate comprises a first edge protruded away from the second display substrate, and the buffer member and the adhesive member are disposed between the first edge and the window.

At a side of the display panel where the first edge is located, the buffer member contacts a side surface of the sealing member and a side surface of the second display substrate.

The first display substrate further comprises a second edge coincident with an edge of the second display substrate, and at a side of the display panel where the second edge is located, the buffer member contacts a side surface of the sealing member, a side surface of the second edge, and a side surface of the edge of the second display substrate.

The buffer member has a height less than a distance between the window and the first display substrate.

Each of the adhesive member and the buffer member comprises a photo-curable resin.

The window has a light transmitting property.

In an exemplary embodiment of the inventive concept, there is provided a liquid crystal display apparatus comprising: a first display substrate; a second display substrate; a liquid crystal layer disposed between the first and second display substrates; a sealing member disposed between the first and second substrates and adjacent to the liquid crystal layer; an adhesive member overlapping the second display substrate; a window overlapping the adhesive member; and a buffer member disposed between the window and the first display substrate, wherein the buffer member contacts the adhesive member, the sealing member and the second display substrate.

The buffer member is disposed at a first side of the sealing member and the liquid crystal layer is disposed at a second side of the sealing member.

The buffer member directly contacts the first display substrate and the window.

### BRIEF DESCRIPTION OF THE FIGURES

Exemplary embodiments of the inventive concept will be more clearly understood from the following detailed description taken in conjunction with the accompanying drawings in which:

FIG. 1 is an exploded perspective view illustrating a display device according to an exemplary embodiment of the inventive concept;

FIG. 2A is a cross-sectional view taken along line I-I′ of FIG. 1, according to an exemplary embodiment of the inventive concept;

FIG. 2B is a plan view illustrating a coupling relationship between a display panel and a buffer member in FIG. 1, according to an exemplary embodiment of the inventive concept;

FIG. 3A is an enlarged view illustrating a cross-section of a first edge of a first display substrate in FIGS. 2A and 2B, according to an exemplary embodiment of the inventive concept;

FIG. 3B is an enlarged view illustrating a cross-section of a second edge of the first display substrate in FIGS. 1 and 2B, according to an exemplary embodiment of the inventive concept;

FIG. 4 is an enlarged view illustrating a cross-section of a first edge of a display substrate according to an exemplary embodiment of the inventive concept;

FIG. 5 is an enlarged view illustrating a cross-section of a first edge of a first display substrate according to an exemplary embodiment of the inventive concept;

FIG. 6 is a plan view illustrating a coupling relationship between a display panel and a buffer member according to an exemplary embodiment of the inventive concept; and

FIGS. 7A and 7B are views illustrating a coupling relationship between a display panel and a buffer member according to an exemplary embodiment of the inventive concept.

### DETAILED DESCRIPTION OF THE EMBODIMENTS

Hereinafter, exemplary embodiments of the present inventive concept will be described below in more detail with reference to the accompanying drawings. The inventive concept may, however, be embodied in different forms and should not be construed as limited to the embodiments set forth herein. Like reference numerals may refer to like elements throughout the specification.

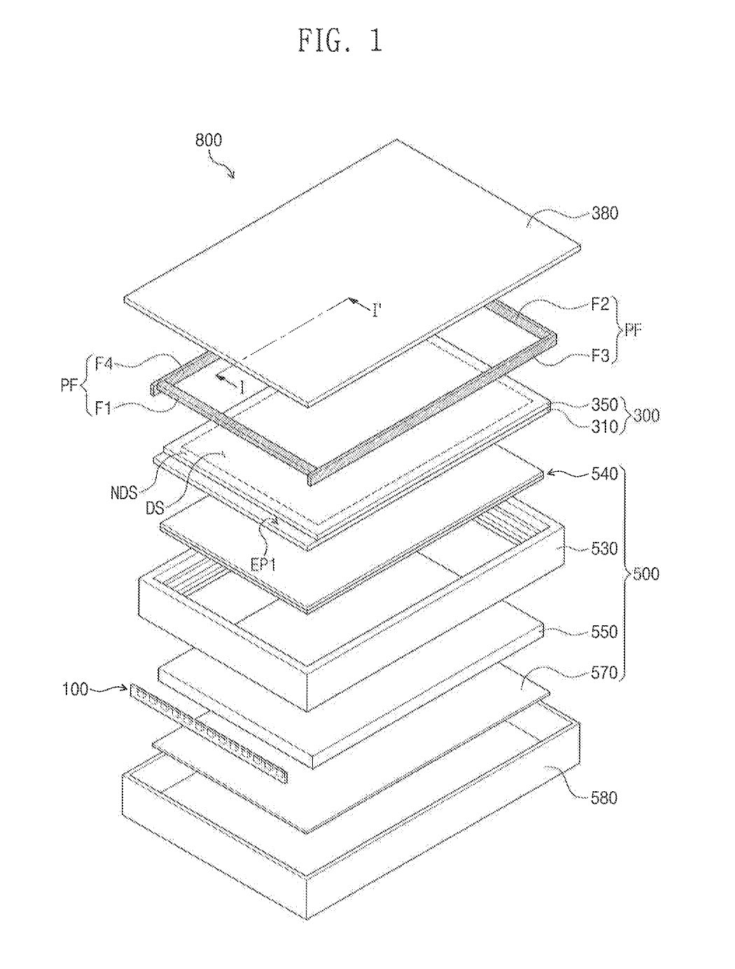

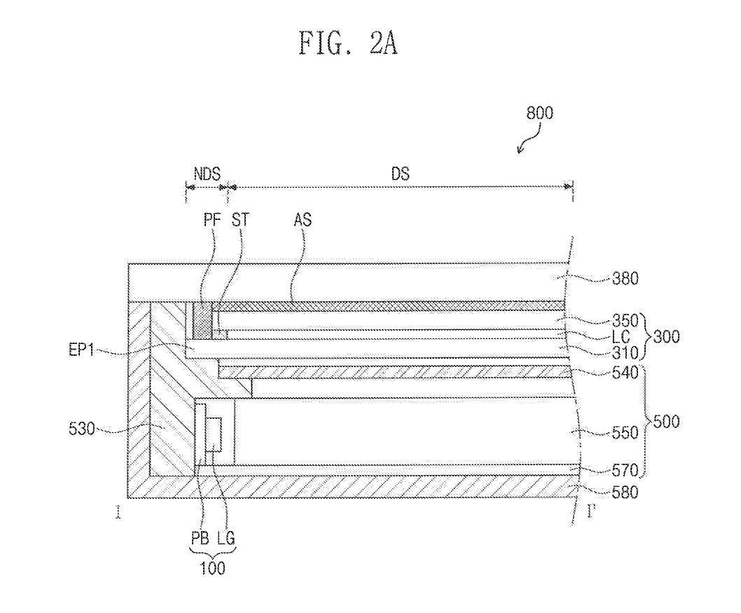

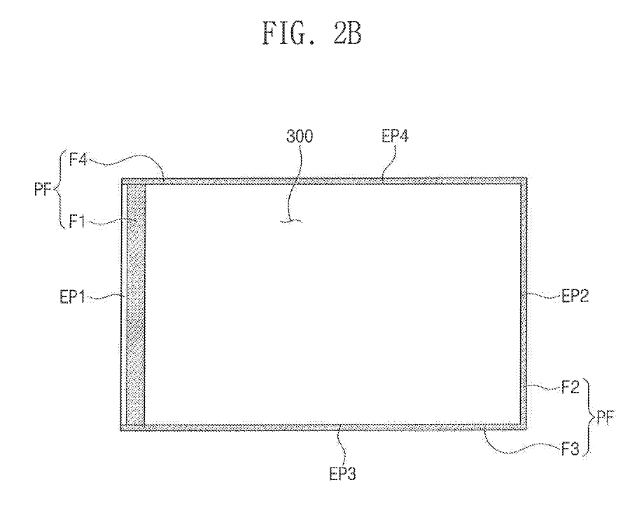

FIG. 1 is an exploded perspective view illustrating a display apparatus according to an exemplary embodiment of the inventive concept, FIG. 2A is a cross-sectional view taken along line I-I′ of FIG. 1, according to an exemplary embodiment of the inventive concept, and FIG. 2B is a plan view illustrating a coupling relationship between a display panel 300 and a buffer member PF in FIG. 1, according to an exemplary embodiment of the inventive concept.

Referring to FIGS. 1, 2A, and 2B, a display apparatus 800 includes the display panel 300, a window 380, an adhesive member AS, a backlight assembly 500, and an accommodation member 580.

The display panel 300 includes a display area DS and a non-display area NDS surrounding the display area DS. The display panel 300 displays an image through the display area DS. In this embodiment, the display panel 300 may be a liquid crystal display panel and receive light emitted from the backlight assembly 500 to display the image.

The display panel 300 includes a first display substrate 310, a second display substrate 350, a liquid crystal layer LC, a sealing member ST, and the buffer member PF.

The first and second display substrates 310 and 350 face each other, and the liquid crystal layer LC is disposed between the first and second display substrates 310 and 350. In this embodiment, the first display substrate 310 may include a plurality of pixel electrodes in the display area DA, and the second display substrate 350 may include a common electrode facing the plurality of pixel electrodes with the liquid crystal layer LC therebetween. However, the inventive concept is not limited thereto. For example, the first display substrate 310 may include a plurality of pixel electrodes in the display area DS and a common electrode spaced apart from the plurality of pixel electrodes. In this case, liquid crystal molecules of the liquid crystal layer LC may be operated in a plan-to-line switching (PLS) mode with respect to an electric field between each of the plurality of pixel electrodes and the common electrode.

In the embodiment shown in FIGS. 1 to 2B, the first display substrate 310 may have a size greater than that of the second display substrate 350. Accordingly, in one edge of the display panel 300, an edge of the first display substrate 310 may be disposed outside the second display substrate 350 on a plane so as not to overlap the second display substrate 350. In other words, an edge of the first display substrate 310 may protrude beyond an edge of the second display substrate 350 such that it is not overlapped by the second display substrate 350. As a result, the edge of the first display substrate 310 may be exposed to the window 380.

For example, the first display substrate 310 may include a first edge EP1, a second edge EP2, a third edge EP3, and a fourth edge EP4, which one-to-one correspond to four edges of the display panel 300. In this case, each of the second to fourth edges EP2, EP3, and EP4 overlaps a corresponding edge of the second display substrate 350. And each of side surfaces of the second to fourth edges EP2, EP3, and EP4 is aligned with a side surface of the edge of the second display substrate 350. On the other hand, the first edge EP1 may not be aligned with a side surface of a corresponding edge of the second display substrate 350 and be exposed to the window 380. In this embodiment, a driving chip for controlling input of data signals provided to the display panel 300 may be provided on the first edge EP1.

The sealing member ST is disposed between the first and second display substrates 310 and 350 in the non-display area NDS. In this embodiment, when the display panel 300 has a rectangular shape, the sealing member ST may have a closed-loop shape extending along the four edges of the display panel 300. The sealing member ST couples the first display substrate 310 to the second display substrate 350 and seals the liquid crystal layer LC between the first and second display substrates 310 and 350.

The buffer member PF contacts the sealing member ST and is disposed between the window 380 and the first display substrate 310. The buffer member PF buffers shock that may be applied to the window 380 and transmitted to the display panel 300.

In this embodiment, the buffer member PF may be a double-sided tape. The buffer member PF may have a composition material including a polymer material such as polyethylene terephthalate (PET) and Polymethylmethacrylate (PMMA).

In this embodiment, the buffer member PF may include a first buffer F1, a second buffer F2, a third buffer F3, and a fourth buffer F4. The first to fourth buffers F1, F2, F3, and F4 are disposed one-by-one to correspond to the first to fourth edges EP1, EP2, EP3, and EP4.

In this embodiment, each of the first and second buffers F1 and F2 has a linear shape extending along a short side of the display panel 300, and each of the third and fourth buffers F3 and F4 has a linear shape extending along a long side of the display panel 300.

The window 380 covers the display panel 300 to protect the display panel 300 from external shock. In this embodiment, the window 380 may be a glass substrate or a plastic substrate, which has a light transmitting property, and the window 380 may have a size greater than that of the display panel 300 to cover the display area DS and the non-display area NDS of the display panel 300.

In this embodiment, a coating layer and a light shielding layer may be disposed on the window 380. The coating layer may be applied to a surface of the window 380 to increase hardness of the window 380.

In this embodiment, the coating layer may include an organic material, an inorganic material, or a hybrid material in which the organic material and the inorganic material are mixed with each other. For example, the organic material may include an acryl-base compound and an epoxy-based compound, and the inorganic material may include silica and alumina.

In this embodiment, the light shielding layer includes carbon black or pigment to absorb light or metal to reflect light. Accordingly, a light shielding area may be provided on the window 380 in an area where the light shielding layer is disposed, and a light transmitting area may be provided on the window 380 in an area where the light shielding layer is not disposed. For example, in this embodiment, the light shielding layer may overlap the non-display area NDS of the display panel 300 such that the area of this overlap is the light shielding area.

The adhesive member AS is disposed between the display panel 300 and the window 380 to allow the display panel 300 to be adhered to the window 380. In this embodiment, the adhesive member AS may include a resin having a light transmitting property.

The backlight assembly 500 emits light toward the display panel 300. The inventive concept is not limited to the structure of the backlight assembly 500 hereinafter described.

In this embodiment, the backlight assembly 500 includes a light emitting unit 100, a reflective member 570, a light guide plate 550, and a mold frame 530, and an optical member 540.

The light emitting unit 100 emits light. In this embodiment, the light emitting unit 100 may include a printed circuit board PB and a plurality of light emitting diodes LG mounted on the printed circuit board PB to emit the light. The printed circuit board PB may extend along one edge of the light guide plate 550, and the plurality of light emitting diodes LG may be mounted on the printed circuit board PB and arranged in a longitudinal direction of the one edge of the light guide plate 550.

The reflective member 570 has light reflectivity and is accommodated in the accommodation member 580. In this embodiment, a composition material of the reflective member 570 may include polyethylene terephthalate (PET) and polyester. Accordingly, light leaked through a rear surface of the light guide plate 550 may be reflected back to the light guide plate 550 by the reflective member 570. In this embodiment, the reflective member 570 may have a sheet shape. However, the inventive concept is not limited to the structure of the reflective member 570. For example, the reflective member 570 may include a reflective material such as silver (Ag) and be applied to the rear surface of the light guide plate 550.

The light guide plate 550 is disposed between the reflective member 570 and the optical member 540. The light generated from the light emitting unit 100 is incident into the light guide plate 550, and the light guide plate 550 guides the incident light toward the display panel 300.

The mold frame 530 is coupled to the accommodation member 580, and the mold frame 530 extends along the edges of the light guide plate 550 and is coupled to the edges of the light guide plate 550. The mold frame 530 may have a stepped portion having a stepped shape in an inside thereof, and the optical member 540 and the display panel 300 may be laminated on the stepped portion.

The optical member 540 is disposed between the display panel 300 and the light guide plate 550. In this embodiment, the optical member 540 may include optical sheets for adjusting a path of light emitted from the light guide plate 550 and incident into the display panel 300. The optical sheets may include a prism sheet and a diffusion sheet.

The accommodation member 580 includes a bottom portion and a plurality of sidewalls extending from the bottom portion to provide an accommodation space. Components of the above-described backlight assembly 500 are accommodated in the accommodation space. In this embodiment, the reflective member 570, the light guide plate 550, and the optical member 540 may be sequentially accommodated in the accommodation space from the bottom portion of the accommodation member 580.

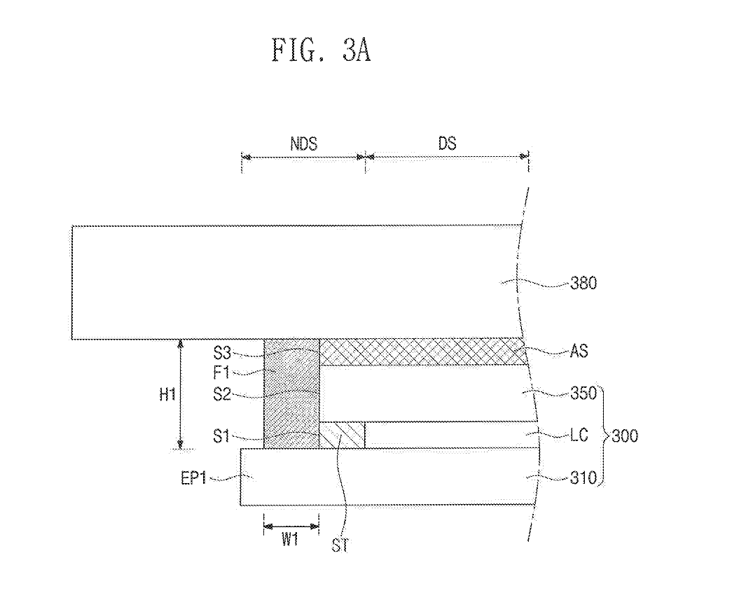

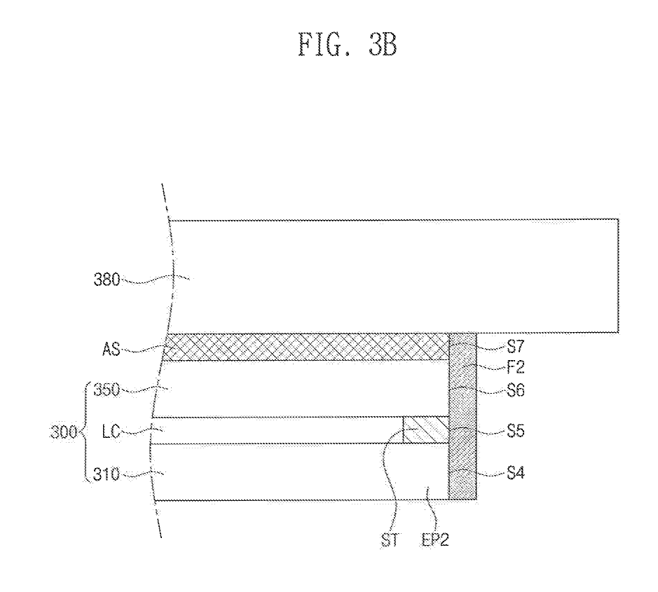

Hereinafter, with reference to FIGS. 3A and 3B, the function and structure of the buffer member PF will be described in more detail as follows.

FIG. 3A is an enlarged view of a cross-section of the first edge EP1 of the first display substrate 310 in FIGS. 2A and 2B, according to an exemplary embodiment of the inventive concept, and FIG. 3B is an enlarged view of a cross-section of the second edge EP2 of the first display substrate 310 in FIGS. 1 and 2B, according to an exemplary embodiment of the inventive concept.

First, referring to FIGS. 2A, 2B, and 3A, the adhesive member AS is disposed between the window 380 and the display panel 300. Here, the adhesive member AS may not overlap the first edge EP1 of the first display substrate 310 on a plane.

In addition, the first buffer F1 of the buffer member PF is disposed on the first edge EP1 of the first display substrate 310, and the first buffer F1 is adhered to the first edge EP1 and the window 380 to couple the first edge EP1 to the window 380. In addition, the first buffer F1 is disposed farther away from the liquid crystal layer LC than the sealing member ST and contacts the sealing member ST and the window 380. A first height H1 may be substantially the same as a distance between the window 380 and the first display substrate 310.

According to the above-described structure of the first buffer F1, the first buffer F1 is disposed between the first edge EP1 and the window 380 to contact a first side surface S1 of the sealing member ST, a second side surface S2 of the second display substrate 350, and a third side surface S3 of the adhesive member AS. Accordingly, the buffer member PF can buffer a shock wave applied to the window 380 from the outside.

For example, a shock wave generated by a shock applied to the window 380 may be transmitted to the liquid crystal layer LC through the adhesive member AS, the second display substrate 350, and the sealing member ST in order. In addition, since the sealing member ST contacts each of the first and second display substrates 310 and 350 to support the first and second display substrates 310 and 350, the shock wave may be concentrated on the sealing member ST. Accordingly, although the sealing member ST can block the shock wave applied to the liquid crystal layer LC, since the sealing member ST is in contact with the liquid crystal layer LC, the shock wave may also be transmitted to the liquid crystal layer LC through the sealing member ST.

Regarding the path of the shock wave transmitted to the liquid crystal layer LC through the sealing member ST, since the buffer member PF is in contact with the sealing member ST, the window 380, and the first and second display substrates 310 and 350, the shock wave applied to the window 380 is transmitted to the buffer member PF as well as the sealing member ST.

In contrast to an exemplary embodiment of the inventive concept, when the buffer member PF is omitted from the display panel 300, the shock wave may be concentrated on the sealing member ST and, as a result, a cell gap of the display panel 300 change due to the shock wave transmitted to the liquid crystal layer LC through the sealing member ST. Such change in the cell gap can degrade the display quality of the display panel 300. However, in an exemplary embodiment of the inventive concept, the shock wave transmitted to the sealing member ST may be dispersed toward the buffer member PF, and thus, the path of the shock wave transmitted from the window 380 to the liquid crystal layer LC may extend by a width W1 of the buffer member PF.

As described above, when the path of the shock wave is extended to the buffer member PF, a portion of the shock wave may be absorbed by the buffer member PF, thereby reducing the intensity of the shock wave transmitted to the liquid crystal layer LC. Accordingly, a change in the cell gap of the display panel 300 due to the shock wave may be reduced, thereby minimizing the degradation in the display quality of the display panel 300.

Referring to FIGS. 2B and 3B, a second buffer F2 of the buffer member PF is coupled to the second edge EP2 of the first display substrate 310 and is disposed between the second edge EP2 and the window 380. Like the first buffer F1 (refer to FIG. 3A), the second buffer F2 is disposed farther away from the liquid crystal layer LC than the sealing member ST and contacts the sealing member ST and the window 380.

For example, the second buffer F2 contacts a fourth side surface S4 of the second edge EP2 of the first display substrate 310, a fifth side surface S5 of the sealing member ST, a sixth side surface S6 of the second display substrate 350, and a seventh side surface S7 of the adhesive member AS. Accordingly, similarly to the function of the first buffer (refer to F1 in FIG. 3A) previously described with reference to FIG. 3A, the second buffer F2 can reduce the intensity of a shock wave applied to the window 380 and transmitted to the liquid crystal layer LC. Therefore, the degradation in the display quality of the display panel 300, which is caused by variations in the cell gap of the display panel 300 due to shock waves, may be minimized.

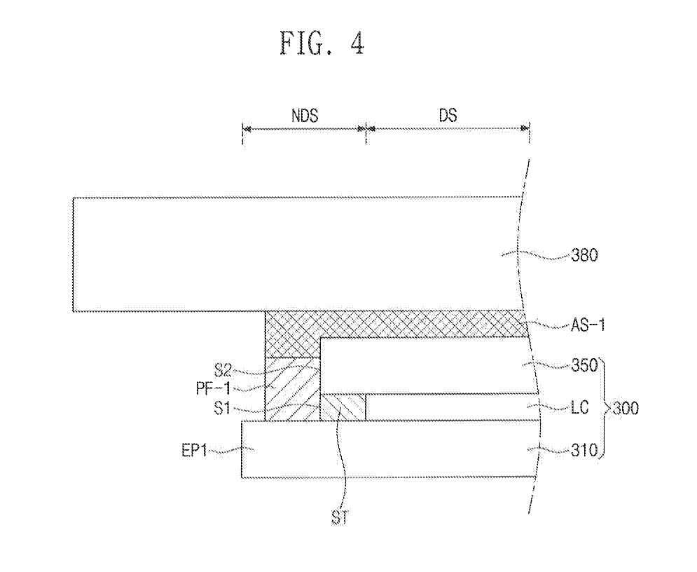

FIG. 4 is an enlarged view of a cross-section of the first edge EP1 of the display substrate 310 according to an exemplary embodiment of the inventive concept. In describing FIG. 4, descriptions of elements made above may be omitted.

Referring to FIG. 4, an adhesive member AS-1 is disposed between the window 380 and the display panel 300. In this embodiment, unlike the embodiment in FIG. 3A, the adhesive member AS-1 overlaps the first edge EP1 of the first substrate 310 on a plane.

In addition, a buffer member PF-1 is disposed between the first edge EP1 and the window 380. For example, the buffer member PF-1 is disposed farther away from the liquid crystal layer LC than the sealing member ST and contacts the sealing member ST and the adhesive member AS-1. In other words, the buffer member PF-1 and the adhesive member AS-1 are disposed between the first edge EP1 and the window 380.

According to the above-described structure of the buffer member PF-1, the buffer member P-F1 is disposed between the first edge EP1 and the window 380 to contact a first side surface S1 of the sealing member ST and a second side surface S2 of the second display substrate 350. Accordingly, the buffer member PF-1 buffers a shock wave applied from outside the window 380 and transmitted to the liquid crystal layer LC together with the adhesive member AS-1. Therefore, degradation in the display quality of the display panel 300, which is caused by variations in the cell gap of the display panel 300 due to shock waves, may be minimized.

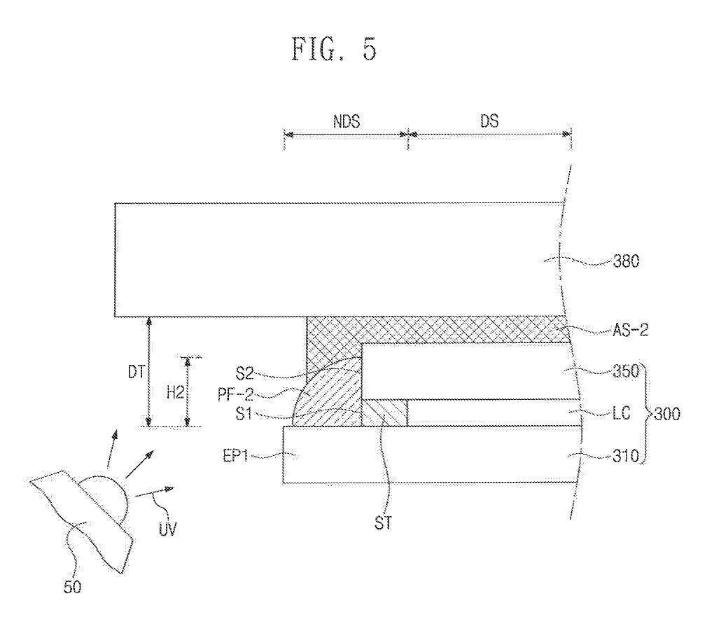

FIG. 5 is an enlarged view of a cross-section of the first edge EP1 of the display substrate 310 according to an exemplar embodiment of the inventive concept. In describing FIG. 5, descriptions of elements made above may be omitted.

Referring to FIG. 5, an adhesive member AS-2 is disposed between the window 380 and the display panel 300 and overlaps the first edge EP1 of the first display substrate 310 on a plane.

Like the embodiment previously described with reference to FIG. 4, a buffer member PF-2 is disposed between the first edge EP1 and the window 380 and is disposed farther from the liquid crystal layer LC than the sealing member ST.

In addition, the buffer member PF-2 contacts the sealing member ST and the adhesive member AS-2, and the buffer member PF-2 and the adhesive member AS-2 are disposed between the first edge EP1 and the window 380. Thus, the buffer member PF-2 may have a height H2 which is less than a distance DT between the window 380 and the first display substrate 310.

According to the above-described structure of the buffer member PF-2, the buffer member PF-2 is disposed between the first edge EP1 and the window 380 to contact a first side surface S1 of the sealing member ST and a second side surface S2 of the second display substrate 350. Accordingly, the buffer member PF-2 buffers a shock wave applied from outside the window 380 and transmitted to the liquid crystal layer LC together with the adhesive member AS-2.

In this embodiment, each of the adhesive member AS-2 and the buffer member PF-2 may include a photo-curable resin. In this case, a first bonding process of bonding the window 380 to the display panel 300 by using the adhesive member AS-2 and a second bonding process of bonding the buffer member PF-2 to the first edge EP1 may be performed at the same time. For example, a first photo-curable resin is applied on the first edge EP1, a second photo-curable resin is applied on the window 380, and then, ultraviolet (UV) rays emitted from an ultraviolet lamp 50 are irradiated to the first and second photo-curable resins. Thus, since the first and second photo-curable resins are substantially cured by the ultraviolet (UV) rays at the same time, the adhesive member AS-2 and the buffer member PF-2 may be bonded at the same time.

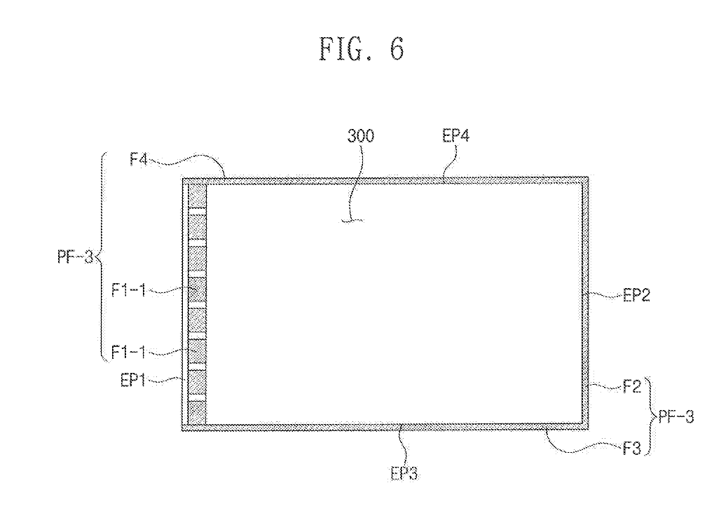

FIG. 6 is a plan view illustrating a coupling relationship between the display panel 300 and the buffer member PF according to an exemplary embodiment of the inventive concept. In describing FIG. 6, descriptions of elements made above may be omitted.

Referring to FIG. 6, in this embodiment, a buffer member PF-3 includes first to fourth buffers F1-1, F2, F3, and F4. The first buffer F1-1 has a shape of dots spaced apart from each other and arranged along a short side of the display panel 300 on the first edge EP1.

In addition, the second to fourth buffers F2, F3, and F4 may be disposed one-by-one to correspond to the second to fourth edges EP2, EP3, and EP4. The second buffer F2 has a linear shape extending along the short side of the display panel 300, and each of the third and fourth buffers F3 and F4 has a linear shape extending along a long side of the display panel 300.

In this embodiment, when the first buffer F1-1 has the shape of the dots spaced apart from each other, a dispersion effect of a shock wave applied from the window (refer to 380 in FIG. 2A) to the first buffer F1-1 is further increased. In other words, the shock wave may be additionally dispersed. In addition, when another component such as a driving chip is disposed on the first edge EP1, the driving chip may be disposed between the dots spaced apart from each other to prevent a stepped portion from being generated on the first buffer F1-1 by the driving chip.

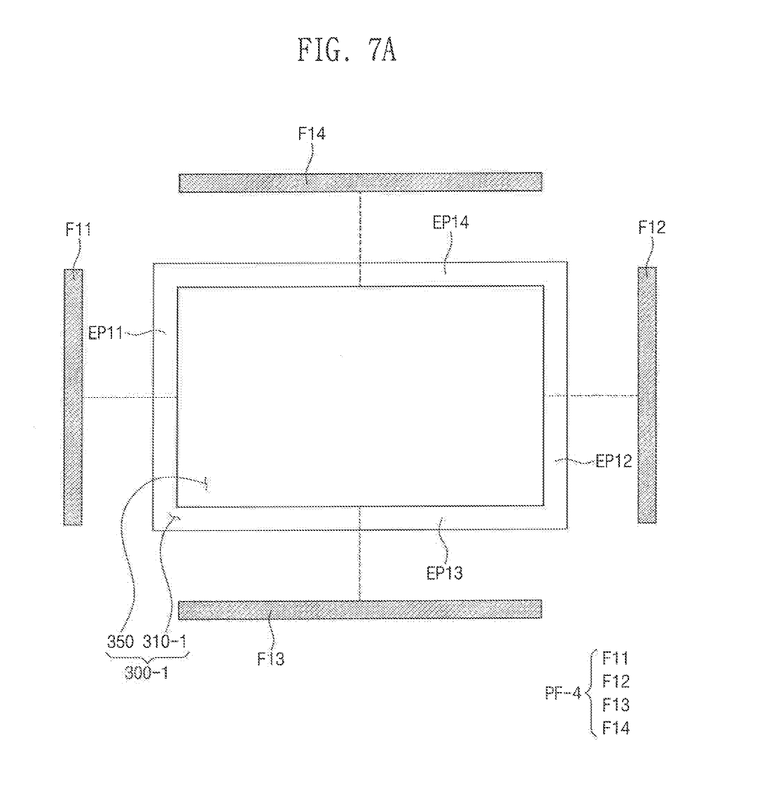

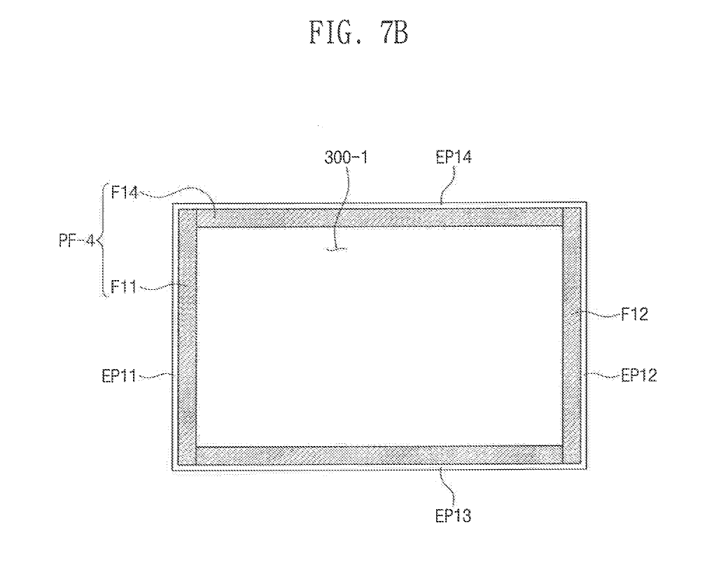

FIGS. 7A and 7B are views illustrating a coupling relationship between a display panel 300-1 and a buffer member PF-4 according to an exemplary embodiment of the inventive concept. For example, FIG. 7A is a view illustrating a state in which the display panel 300-1 and the buffer member PF-4 are separated from each other, and FIG. 7B is a view illustrating a state in which the display panel 300-1 and the buffer member PF-4 are coupled to each other. In describing FIGS. 7A and 7B, descriptions of elements made above may be omitted.

Referring to FIG. 2B, the first edge EP1 of the first display substrate 310 is disposed outside the second display substrate 350 so as not to overlap the second display substrate 350 along one edge of the display panel 300 on a plane. Accordingly, as illustrated in FIG. 3A, in the buffer member PF, the first buffer F1 coupled to the first edge EP1 is disposed on the first edge EP1 (e.g., an upper surface of the first edge EP1) to contact the sealing member ST and the window 380. However, as illustrated in FIG. 3B, there are other buffers in the buffer member PF, which are coupled to edges other than the first edge EP1. For example, the second buffer F2 is coupled to the second edge EP2 and is disposed on a side surface of the second edge EP2 to contact the sealing member ST and the window 380.

Now, referring to FIGS. 3A, 7A, and 7B, each of first to fourth edges EP11, EP12, EP13, and EP14 of the first display substrate 310-1 in a one-to-one correspondence with the four edges of the display panel 300-1 is disposed outside the second display substrate 350 so as not to overlap the second display substrate 350 on a plane.

Accordingly, in this embodiment, since first to fourth buffers F11, F12, F13, and F14 are coupled to the first to fourth edges EP11, EP12, EP13, and EP14 in a one-to-one correspondence, each of the first to fourth buffers F11, F12, F13, and F14 may be disposed on its corresponding edge of the first to fourth edges EP11, EP12, EP13, and EP14 as illustrated in FIG. 3A.

In this embodiment, the first to fourth buffers F11, F12, F13, and F14 may have an integral shape, and each of the first to fourth buffers F11, F12, F13, and F14 may have substantially the same height as a gap between its corresponding edge of the first to fourth edges EP11, EP12, EP13, and EP14 and the window 380 to support and fill the gap. In this case, each of the first to fourth buffers F11, F12, F13, and F14 may simultaneously contact the sealing member ST and the window 380. Therefore, the first to fourth buffers F11, F12, F13, and F14 may reduce the intensity of a shock wave applied from the outside to the window 380 and transmitted to the liquid crystal layer LC. Therefore, the amount of degradation in the display quality of the display panel 300-1, which is caused by a variation of the cell gap of the display panel 300-1 due to the shock wave, may be minimized.

According to exemplary embodiments of the inventive concept, the buffer member is provided on a path through which a shock wave generated by a force applied to the window is transmitted to the liquid crystal layer of the display panel. Consequently, the buffer member contacts the sealing member of the display panel and the window. Thus, the path of the shock wave may increase by as much as the width of the buffer member, and thus, an extra portion of the shock wave is absorbed by the buffer member, thereby reducing the intensity of the shock wave transmitted to the liquid crystal layer.

Due to the configuration and placement of the buffer member, the amount by which the cell gap of the display panel is varied by a shock wave may be reduced. Thus, degradation in the display quality of the display panel, which can result from such cell gap size variations, may be minimized.

Although the present inventive concept has been shown and described with reference to exemplary embodiments thereof, it is understood by those of ordinary skill in the art that various changes in form and detail can be made thereto without departing from the spirit and scope of the present inventive concept as hereinafter claimed.

What is claimed is:

1. A liquid crystal display apparatus, comprising:
a display panel having a display area which displays an image and a non-display area; and
a window which overlaps the display panel,
wherein the display panel comprises:
a first display substrate;
a second display substrate disposed between the first display substrate and the window;
a liquid crystal layer disposed between the first and second display substrates;
a sealing member disposed between the first and second display substrates; and
a buffer member contacting at least one of the first and second display substrates in the non-display area and disposed farther away from the liquid crystal layer than the sealing member,
wherein the buffer member contacts the sealing member and the window.

2. The liquid crystal display apparatus of claim 1, wherein the first display substrate comprises a first edge disposed away from the second display substrate, and
the buffer member couples the first edge to the window.

3. The liquid crystal display apparatus of claim 2, further comprising an adhesive member disposed between the display panel and the window,
wherein the buffer member contacts a first side surface of the sealing member, a side surface of the second display substrate, and a first side surface of the adhesive member.

4. The liquid crystal display apparatus of claim 3, wherein the adhesive member does not overlap the first edge of the first display substrate.

5. The liquid crystal display apparatus of claim 3, wherein the first display substrate further comprises a second edge overlapping an edge of the second display substrate,
wherein, at a side of the display panel where the second edge is located, the buffer member contacts a second side surface of the sealing member, a side surface of the second edge, a side surface of the edge of the second display substrate, and a second side surface of the adhesive member.

6. The liquid crystal display apparatus of claim 1, wherein the buffer member is a double-sided tape.

7. The liquid crystal display apparatus of claim 1, wherein the buffer member comprises a first buffer having a linear shape extending along a first edge of the display panel.

8. The liquid crystal display apparatus of claim 7, wherein the buffer member further comprises a second buffer having a dot-like shape and arranged along a second edge of the display panel.

9. The liquid crystal display apparatus of claim 1, wherein the buffer member has a height that is substantially the same as a distance between the first display substrate and the window.

10. The liquid crystal display apparatus of claim 1, wherein the window has a light transmitting property.

11. A liquid crystal display apparatus, comprising:
a display panel having a display area which displays an image and a non-display area;
a window which covers the display panel; and
an adhesive member disposed between the display panel and the window,
wherein the display panel comprises:
a first display substrate;
a second display substrate disposed between the first display substrate and the window;
a liquid crystal layer disposed between the first and second display substrates;
a sealing member disposed between the first and second display substrates; and
a buffer member contacting at least one of the first and second display substrates in the non-display area and disposed farther away from the liquid crystal layer than the sealing member,
wherein the buffer member contacts the sealing member and the adhesive member.

12. The liquid crystal display apparatus of claim 11, wherein the first display substrate comprises a first edge protruded away from the second display substrate, and
the buffer member and the adhesive member are disposed between the first edge and the window.

13. The liquid crystal display apparatus of claim 12, wherein, at a side of the display panel where the first edge is located, the buffer member contacts a side surface of the sealing member and a side surface of the second display substrate.

14. The liquid crystal display apparatus of claim 12, wherein the first display substrate further comprises a second edge overlapping an edge of the second display substrate, and
at a side of the display panel where the second edge is located, the buffer member contacts a side surface of the sealing member, a side surface of the second edge, and a side surface of the edge of the second display substrate.

15. The liquid crystal display apparatus of claim 11, wherein the buffer member has a height less than a distance between the window and the first display substrate.

16. The liquid crystal display apparatus of claim 11, wherein each of the adhesive member and the buffer member comprises a photo-curable resin.

17. The liquid crystal display apparatus of claim 11, wherein the window has a light transmitting property.

18. A liquid crystal display apparatus, comprising:
a first display substrate;
a second display substrate;
a liquid crystal layer disposed between the first and second display substrates;
a sealing member disposed between the first and second substrates and adjacent to the liquid crystal layer;
an adhesive member overlapping the second display substrate;
a window overlapping the adhesive member; and
a buffer member disposed between the window and the first display substrate, wherein the buffer member contacts the adhesive member, the sealing member and the second display substrate.

19. The liquid crystal display apparatus of claim 18, wherein the buffer member is disposed at a first side of the sealing member and the liquid crystal layer is disposed at a second side of the sealing member.

20. The liquid crystal display apparatus of claim 18, wherein the buffer member directly contacts the first display substrate and the window.
